(19) United States
(12) Patent Application Publication
(10) Pub. No.: US 2007/0050950 A1
(43) Pub. Date: Mar. 8, 2007

(54) Stabilization of waste material

(76) Inventor: Gavin Patrick Gillman, Queensland (AU)

Correspondence Address: FOLEY AND LARDNER LLP;SUITE 500, 3000 K STREET NW, WASHINGTON, DC, 20007, US

(21) Appl. No.: 10/555,665

(22) PCT Filed: May 5, 2004
(86) PCT No.: PCT/AU04/00580

§ 371 Date: Nov. 4, 2005

(30) Foreign Application Priority Data
May 7, 2003 (AU) 2003902178

(51) Int. Cl. B29C 71/00; C05B 19/00; C22B 1/14

(52) U.S. Cl. 23/313 R; 264/234

(57) ABSTRACT

A method for treating waste material containing manure from animal feedlots includes the steps of mixing the material with a layered double hydroxide material, a clay material and optionally water to form a mixture, the layered double hydroxide material being added in an amount sufficient to sequester anions present in the waste sludge or slurry, the layered double hydroxide material and clay material and optionally water being added in an amount sufficient to form a workable mixture for granulating, and subjecting the mixture to a granulating process and a drying process to form dried granules. The method allows intractable feedlot wastes to be effectively treated and disposed.

### FIELD OF THE INVENTION

The present invention relates to a method for the treatment of waste materials, such as waste sludge or slurry containing manure from animal feedlots.

### BACKGROUND OF THE INVENTION

The continued expansion of feedlot animal production (such as chickens, pigs and cattle) has led to increasing amounts of manure for disposal. For instance, it is estimated that broiler production in the mid Atlantic region of the United States (accounting for only 13% of United States broiler production) results in 720,000 tonnes of manure being generated per year. Indeed, current estimates of the annual production of feedlot manures in the US and Europe totals approximately 1.7 billion tonnes. Feedlot manures and effluents have relative high contents of phosphates and other environmentally sensitive species.

The manure recovered from animal feedlots is typically in the form of a sludge or slurry, although chicken manure may be recovered in a relatively dry state. The sludges and slurries, especially from piggeries, can be a gel-like material that is difficult to separate into solid and liquid components. Additionally, the sludges and slurries have a quite offensive odour. Disposal of the sludges and slurries represents a significant issue for feedlot managers.

The most economical disposal of manure involves application of the manure to land for plant nutrition. However, costs associated with the transport of intractable materials, and limited availability of sites close to feedlots, often results in heavy applications of manure on available areas. If nutrients are applied in excess of plant requirements, enrichment of watersheds occurs through leaching and overland flow, with consequent damage to the environment. In this regards, the majority of elements potentially available for leaching from sludges and manures are in ionic form.

Further difficulties are also involved in the disposal of feedlot manures in that the manures (typically in the form of a sludge or slurry) are difficult to handle, must be stored with care and have an unpleasant odour. Disposal currently requires extensive manpower and capital expenditure. Disposal by spreading on the land must avoid soil compaction and requires equipment capable of high work rates. Presently available disposal methods are generally unsatisfactory for not meeting one or more of the problems described above.

Layered double hydroxides (hereinafter referred to as “LDH compounds”) are mixed hydroxides of divalent and tri-valent metals having an excess of positive charge that is balanced by interlayer anions. They can be represented by the general formula (1).
M₁₋ₓ²⁺Mₓ³⁺(OH)₂A_{x/n}ⁿ⁻yH₂O (1)

where M²⁺ and M³⁺ are di- and tri-valent metal ions respectively and Aⁿ⁻ is the interlayer anion of valance n. The x value represents the proportion of trivalent metal to the total amount of metal ion present and y denotes variable amounts of interlayer water.

Common forms of LDH comprise Mg²⁺ and Al³⁺ (known as hydrotalcites) and Mg²⁺ and Fe³⁺ (known as pyroaurites), but other cations including Ni, Zn, Mn, Ca, Cr, and La are known. The amount of surface positive charge generated is dependent upon the mole ratio of the metal ions in the lattice structure, and the conditions of preparation as they affect crystal formation. LDH compounds are well known in industry, being used as catalysts in organic conversion reaction, PVC stabilisers, flame retardants, medical antacids, and in wastewater treatment.

In our international patent application no. PCT/AU00/00026 we describe a method of treating soils by adding an LDH material to the soil to increase the anion exchange capacity of the soil. We also describe a fertiliser in which an LDH material is mixed with nutrient anions such that the nutrient anions are released when the fertiliser is added to the soil. Fertilisers containing clays and nutrient cations are also described in the PCT application. The fertilisers are designed to provide a controlled amount of nutrient ions for delivery to a crop growing in the soil.

### BRIEF DESCRIPTION OF THE INVENTION

In a first aspect, the present invention provides a method for treating waste material containing manure from animal feedlots, the method including the steps of mixing the material with a layered double hydroxide material, optionally a clay material and optionally water to form a mixture, said layered double hydroxide material being added in an amount sufficient to sequester anions present in the waste sludge or slurry, said layered double hydroxide material and optionally clay material and optionally water being added in an amount sufficient to form a workable mixture for granulating, and subjecting the mixture to a granulating process and a drying process to form dried granules.

In a preferred embodiment, the amount of layered double hydroxide material added to the waste material is determined by adding trial amounts of layered double hydroxide material to a sample of the waste material, analysing a liquid component from the waste material for anion content, selecting a liquid component having a desired or pre-determined anion content and selecting the amount of layered double hydroxide material added to the waste sample from which the selected liquid component was obtained as the determined amount of layered double hydroxide material. More preferably, the amount of layered double hydroxide material added to the waste material is in excess of the determined amount.

For example, a number of aliquots of a waste slurry were obtained and mixed with 10%, 15%, 20%, 25% and 30% by weight (say) of a layered double hydroxide material. Analysis of a liquid component from each treated aliquot revealed that the aliquots treated with 25% and 30% layered double hydroxide material had acceptable anion contents. Thus, the minimum amount of layered double hydroxide material to add to this particular waste slurry would be 25% by weight.

In another embodiment, the amount of layered double hydroxide material to be added to the waste material is determined by determining the amount of soluble anions in the waste material and adding at least sufficient LDH material to sequester the determined amount of soluble anions.

Preferably, the waste material is a waste sludge or slurry and the amount of layered double hydroxide material to be added to the waste sludge or slurry is determined by determining the amount of dissolved anions and leachable anions in the waste sludge or slurry and adding at least sufficient layered double hydroxide material to sequester the determined amount of dissolved and leachable anions. More preferably, the amount of layered double hydroxide material added to the waste sludge or slurry is in excess of the amount required to sequester the determined amount of dissolved and leachable anions.

The amount of layered double hydroxide material that is to be added to sequester the determined amount of dissolved and leachable anions may be determined by determining the anion exchange capacity of the layered double hydroxide material, and calculating the amount of layered double hydroxide material required to sequester the determined amount of dissolved and leachable anions.

The amount of dissolved and leachable anions present in the waste sludge or slurry may be determined by separating the sludge or slurry into a liquid fraction and a solid fraction, analysing the liquid fraction to determine the amount of dissolved anions, and subjecting the solid fraction to a leaching test to determine the amount of leachable anions.

As will be appreciated by those skilled in the art, the amount soluble anions present in the waste material, or the amount of dissolved and leachable anions present in the waste sludge or slurry, can vary greatly, depending on, for example, the type of animal in the feedlot and the composition of the diet fed to the animals. Consequently, it is difficult to provide any quantification of the amount of layered double hydroxide material to be added to the waste material. For this reason, it is preferred that the waste material be analysed to determine the anion content thereof and the amount of layered double hydroxide material to be added then being calculated. Suitably, the calculated amount of layered double hydroxide material represents the minimum amount of layered double hydroxide material to add.

It will also be understood that, in ongoing operation of the method of the present invention, an initial analysis and calculation may be conducted in order to determine the minimum amount of layered double hydroxide material to be added and subsequent addition of layered double hydroxide material may be determined with reference to the initial calculation. In this manner, ongoing analysis of the waste sludge or slurry can be avoided and subsequent additions of layered double hydroxide material can be based on the initial determination of the amount of layered double hydroxide material required per unit volume or weight of the waste sludge or slurry. This approach is more robust, in terms of obtaining sequestration of anions, if the layered double hydroxide material is added in excess of the amount initially calculated. By adding the layered double hydroxide material in excess, fluctuations in the content of leachable and dissolved anions in the waste sludge or slurry can be largely accounted for.

The layered double hydroxide material is preferably of the general formula (1) as given above.

Common forms of LDH comprise Mg²⁺ and Al³⁺ (known as hydrotalcites) and Mg²⁺ and Fe²⁺ (known as pyroaurites), but other cations including Ni, Zn, Mn, Ca, Cr and La are known. The amount of surface positive charge generated is dependent upon the mole ratio of the metal ions in the lattice structure, and the conditions of preparation as they affect crystal formation. Hydrotalcite is preferably used in the present invention.

The LDH preferably contains Cl⁻ ions as its interlayer anions as Cl⁻ ions are relatively environmentally benign. When an LDH material is used as the anion-exchange material, anions such as phosphate, sulphate and organic anions are exchanged into the LDH interlayers.

Alternatively, the layered double hydroxide material may contain nitrate as the interlayer anion. Nitrate is useful as the interlayer anion as nitrate anions are not as tightly held by layered double hydroxide materials, such as hydrotalcite, as other anions. Indeed, the selectivity of hydrotalcites to various interlayer anions differs with a selectivity series in the approximate order:
CO₃²⁻>HPO₄²⁻>>SO₄²⁻,OH⁻>F⁻>Cl⁻>NO₃⁻

The anions at the top of the order are more tightly held by the hydrotalcite than the anions at the bottom of the order. As can be seen from this series, adding hydrotalcite containing nitrate as the interlayer anion results in anions in the sludge or slurry being ion exchange with the interlayer nitrate anions such that the deleterious anions in the sludge or slurry are sequestered by the hydrotalcite. This, of course, releases nitrate anions into solution by the ion exchange mechanism taking place.

The clay material, when required, is added to the mixture primarily to obtain a workable mixture that is suitable for subsequent granulation. Addition of the clay material assists in forming a workable mixture that can be granulated to form relatively stable granules.

The amount of clay material added to the mixture will depend upon the liquid content of the waste material and the amount of layered double hydroxide material added to the waste material. It will also depend upon the particular granulating technique or process to be used. Where the waste material is relatively dry, it may also be necessary to add water to the waste material. The person skilled in the art will be able to readily determine, from experience or from simple trial and error experimentation, the amount of clay material to be added (and water, if required).

Alternatively, for relatively dry waste materials, such as chicken manure recovered from chicken feedlots, it may be necessary to add only the layered double hydroxide material to obtain a workable mixture.

The clay material that may be used in the present invention includes natural clays and synthetic clays. Natural clays that may be used include bentonite, montmorillonite, kaolinite, halloysite, illite, chlorite, attapulgite and allophane. Bentonite is especially suitable. Synthetic clays that may be used in the present invention include dawsonite and XAM (as described in Australian patent no. 702624, the entire contents of which are incorporated herein by cross reference).

In addition to the primary role of the clay material of providing workability to the mixture to enable granulation, the clay material has an additional beneficial effect in that it will also tend to sequester soluble cations in the waste sludge or slurry and also increase the cation exchange capacity of soil if the granules are added to the soil.

The granulating process used in the present invention may be any process known to be suitable for forming granules. Some examples of suitable granulating processes include granulating using rotating inclined tables, rotating drums, fluidised beds, high speed choppers or extrusion.

The granules formed in the granulating process may have any desired size, with the size of the granules being selected according to ease of processing and formation as well as ease of handling and transport of the dried granules.

Where the waste material is a relatively dry material, such as chicken manure from a battery farm, it may be necessary to add water to the waste material in order to obtain a workable mixture. The water may be added to the waste material prior to mixing with the layered double hydroxide material (in which case the waste material becomes a waste sludge or slurry) or it may be added together with or even after addition of one or both of the layered double hydroxide material and the clay material.

The granules that are formed in the method of the present invention are dried. The drying step may form part of the granulating process (e.g. as in spray drying) or it may take place as a separate step to the formation of the granules. If the granules are not dried to reduce their water content, there is a risk that the granules could coalesce into amorphous lumps during storage and transport. Drying also increases the strength of the granules to produce more sturdy granules that have better handling characteristics. Drying also reduces the amount of water to be stored and transported, thereby reducing both storage and transport costs.

The drying step is preferably carried out by passing the granules through a drier. The drier is preferably operated at elevated temperature. Even more preferably, the drier is operated at a temperature of from 20° C. to 100° C. The water removed from the granules may be recovered and reused, for example, by condensing the water vapour from the atmosphere removed from the drier.

In some embodiments of the present invention, if the waste material is a waste sludge or slurry having a particularly high water content, the method may further include the steps of removing part of the water from the waste slurry or sludge, treating the removed part of the water to remove dissolved anions therefrom and treating the waste sludge or slurry in accordance with the method of the present invention.

In this embodiment, the removed part of the water may be contacted with a layered double hydroxide material to remove dissolved anions. The layered double hydroxide material is suitably hydrotalcite containing nitrate as an interlayer anion. In this case, nitrate anions are not removed from the water and it may be necessary to further subject the water to a denitrification process. The denitrification process may be any suitable known process. In this particular embodiment, the layered double hydroxide material that is used to treat the removed part of the water may not become saturated with the anions removed from the water and thus the layered double hydroxide material could be added to the waste sludge or slurry, either as all of the layered double hydroxide material added to the waste sludge or slurry or as a complement to other layered double hydroxide material added to the waste sludge or slurry.

In some instances of this embodiment of the present invention, if the removed part of the water has relatively low levels of dissolved anions, it may not be necessary to treat the removed part of the water before reusing the water.

The removed part of the water may be reused as irrigation water or as water used in the operation of the feedlots.

The granules produced by the present invention may contain deleterious organisms by virtue of the raw materials used to form the granules including wastes that contain animal manure. If desired, the granules may be subjected to a disinfection treatment to kill deleterious organisms therein. The disinfection treatment may be a heat treatment. The heat treatment may be or form part of the drying step. The disinfection treatment may be an irradiation treatment.

The process of the present invention treats waste materials such as waste sludges or slurries containing manure from animal feedlots and produces granules of a stabilised material that is environmentally benign, easily stored and easily transported and handled. The process uses inexpensive feed materials and provides a cost effective treatment option for treating what can be almost intractable wastes. For example, piggery pond sludge is commonly a gel-like product having high levels of soluble phosphates and a particularly unpleasant odour. Piggery effluent can be successfully treated by the method of the present invention.

The present invention has the potential to reduce large scale on-site storage areas currently required for storing waste sludge and slurry on animal feedlots and potentially can reduce or eliminate restrictions to feedlot expansion. Moreover, the granulated product resulting from the method of the present invention can be sold and thus the present invention can convert a net cost into net income. The granulated material, either by itself or mixed with other metals, can provide environmentally acceptable fertilisers or soil amendments.

The granulated material produced by the method of the present invention can be disposed of in a land fill or by dispersing it over the land or over fields. Although the anions and cations in the granules are unlikely to be permanently affixed to the layered double hydroxide material or the clay material in the granules, they are likely to be released at a relatively slow rate that is not environmentally damaging. Indeed, the slow rate of release of some ions from the granules may be beneficial if those ions are environmentally beneficial at low levels or at low rates of application to the environment. For example, if the ions from the waste sludge or slurry are plant nutrients (such as phosphates, nitrates, silicates, potassium or calcium) the granules can advantageously be applied to the land.

As a further distinguishing feature between the present invention and the disclosure of our earlier international patent application no. PCT/AU00/00026, the earlier international patent application formed fertilisers by contacting the layered double hydroxide material and clay material with concentrated solutions containing the ions to be taken up by the layered double hydroxide material and the clay material. In contrast, the waste sludges and slurries used in the present invention have concentrations of dissolved ions that are orders of magnitude lower, thereby leading skilled addressee away from using the waste sludges and slurries as a feed material in the process described in PCT/AU00/00026.

### BRIEF DESCRIPTION OF THE DRAWINGS

FIG. 1 shows a flowsheet of one embodiment of the present invention;

FIG. 2 shows a flowsheet of a further embodiment of the present invention;

FIG. 3 shows a plot of soluble phosphorus content in a piggery effluent vs added hydrotalcite; and

FIG. 4 shows a plot of soluble phosphorus level in a chicken feedlot effluent mixed with water vs added hydrotalcite.

### DETAILED DESCRIPTION OF THE DRAWINGS

The accompanying drawings have been provided for the purpose of illustrating preferred embodiments of the present invention. It is to be understood that the present invention is not limited solely to the features as described in the drawings.

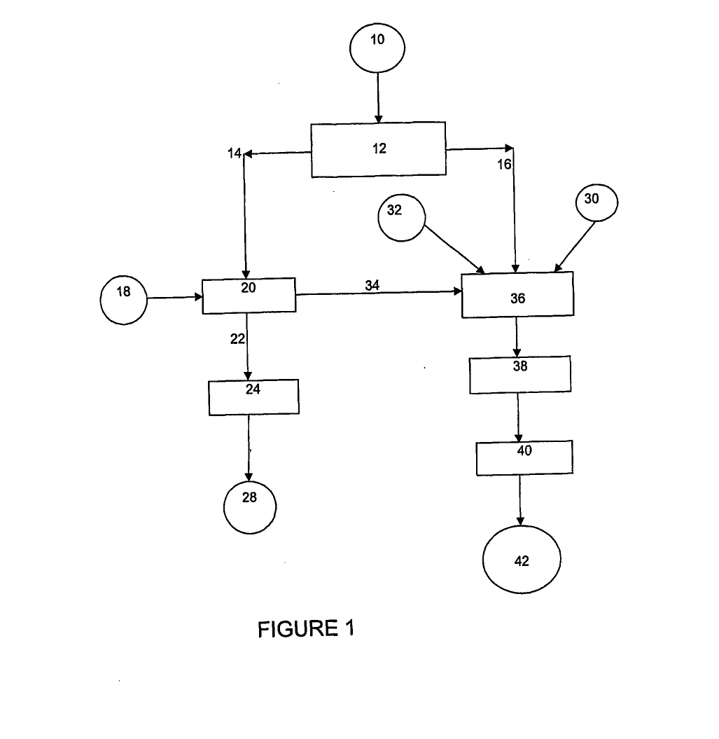

FIG. 1 shows a process flow sheet of a first embodiment in accordance with the present invention. In FIG. 1 sludge 10 from an animal feedlot, such as a piggery or cattle feedlot, is forwarded to a centrifugal separator 12 where the sludge is separated into a liquid stream 14 and a solid stream 16. Although a centrifugal separator 12 is used in FIG. 1, it will be appreciated that any liquid/solid separation means may be used to separate the sludge into the liquid stream 14 and solid stream 16.

Liquid stream 14 will frequently contain significant quantities of dissolved anions. Therefore, it is preferred that the liquid stream 14 is contacted with hydrotalcite 18 in contactor 20. In contactor 20, the deleterious anions in liquid stream 14 are ion exchanged with the interlayer anions in the hydrotalcite 18. Preferably, the hydrotalcite contains chlorine ions or nitrate ions as the interlayer anions.

In cases where the hydrotalcite contains nitrate as the interlayer anions, the nitrate concentration in the liquid stream 14 is increased by the ion exchange that occurs when the hydrotalcite 18 is contacted with the liquid stream 14. Therefore, the liquid stream 22 of enhanced nitrate concentration which leaves contactor 20 is suitably subjected to a denitrifying treatment 24 in order to reduce the nitrate content thereof. The denitrifying treatment 24 may be any conventional denitrification process known to the persons killed in the art. After denitrification the denitrified water 26 is recovered for reuse, as schematically shown at 28.

The solid stream 16 obtained from centrifugal separator 12 is mixed with clay 30, fresh hydrotalcite 32 and hydrotalcite 34 recovered from contacting with the liquid stream 14 in contactor 20. The amount of hydrotalcite added is sufficient to sequester the dissolved and leachable anions in the solid stream 16. The amount of hydrotalcite and clay added is sufficient to form a workable mixture that can be used as a suitable feed mixture to the granulator. It will be understood that the mixture can be hand squeezed to form a coherent shape which shape is self supporting under its own weight.

The solid stream 16, clay 30, fresh hydrotalcite 32 and treated hydrotalcite 34 are mixed together in mixer 36. Mixer 36 may be any suitable mixer known to the person skilled in the art. Mixer 36 intimately mixes all of the components together to obtain a uniformly mixed composition.

The mixture 36 is sent to granulator 38 where it is formed into granules. The granulator may, for example, be an extrusion granulator in which the mixture is extruded into long cylinders that are subsequently broken up into smaller granules. The granules preferably have a diameter in the range of 2-5 mm and a length in the range of 5-20 mm.

The granules are then sent to drier 40 to remove substantially all of the free water from the mixture. The dried granules are then recovered and sent to storage 42. From storage 42, the granules may be transported or disposed of as conveniently available.

The flowsheet shown in FIG. 1 is applicable for sludges or slurries that have a high water content. The liquid/solid separation step 12 is carried out on such sludges in order to minimise the amount of bentonite clay that would otherwise be required to form a workable mixture for the granulation process 36. However, some sludges or slurries may have a water content that does not result in excessive consumption of bentonite clay in forming a workable mixture for the granulation process. For such sludges or slurries, it may be possible to do away with the liquid/solid separation step 12 and the liquid stream treatment steps 20 and 24.

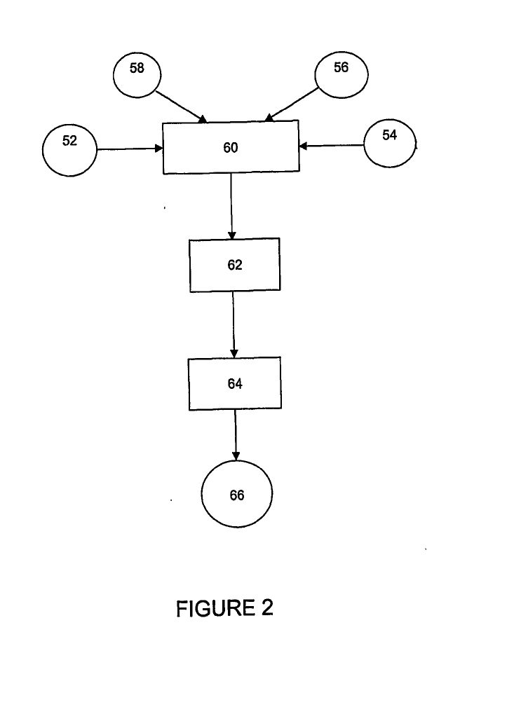

FIG. 2 shows a flowsheet of another embodiment of the present invention. The flowsheet of FIG. 2 is especially suitable for treating dry sludges or slurries, such as chicken manure recovered from a chicken feedlot or a battery hen operation. In the flowsheet shown in FIG. 2, chicken manure 52 is mixed with water 54, hydrotalcite 56 and (optionally) bentonite clay 58 in mixer 60. This step is similar to mixing step 56 shown in FIG. 1, with the addition that water is also added to the mixer. The uniformly mixed mixture is then sent to granulating process 62. The granules are then sent to drier 64 and the dried granules are recovered for storage at 66.

### EXAMPLE 1

A sludge was recovered from the anaerobic pond of a piggery feedlot in the form of a gel-like sludge having extremely unpleasant odour. Supernatant solution obtained by centrifugation of the sludge, upon analysis, contained 47.5 ppm soluble P. The piggery sludge was treated with hydrotalcite containing chloride as an interlayer anion and bentonite and converted into dried granules Hydrotalcite was added in an amount of 10% by weight of the sludge and bentonite was added in an amount of 35% by weight of the sludge. Upon testing the granules in a leaching test, it was found that the granules contained soluble phosphate at only 0.2 ppm. The granules had no discernable odour.

### EXAMPLE 2

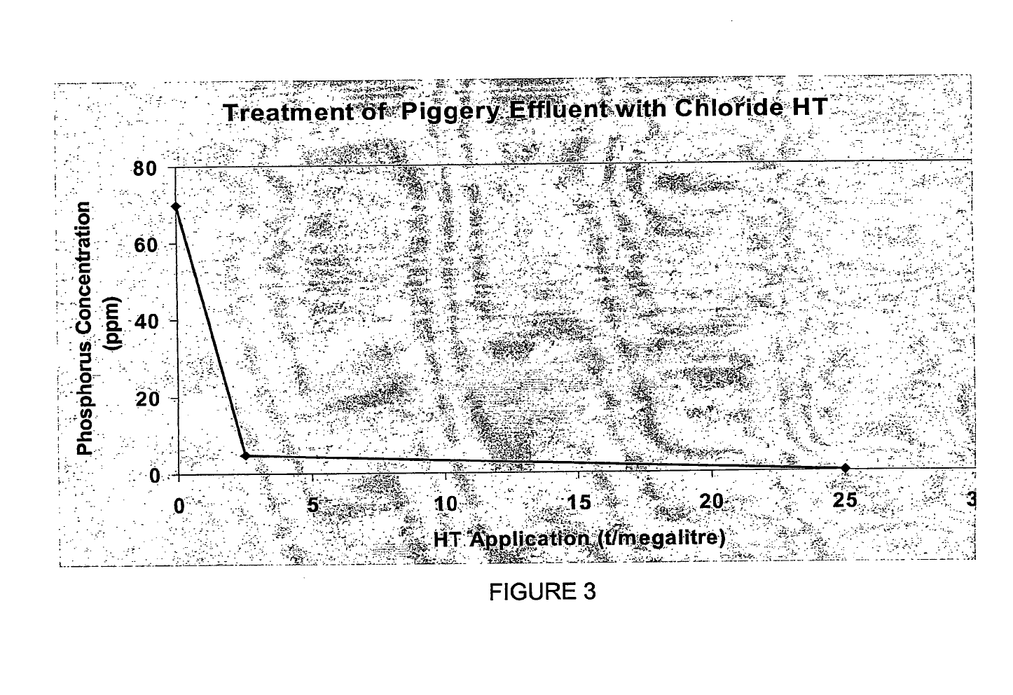

Graded amounts of LDH saturated with chloride were added to aliquots of a supernatant solution obtained by centrifuging a low-solids effluent directly exiting a piggery feedlot. The results are shown in FIG. 3. The phosphate content of the thus treated supernatant solutions indicated that 2.5 tonne HT/megalitre of effluent (0.25%) would be added to obtain satisfactory sequestration of phosphate. From FIG. 3, it can be seen that the hydrotalcite is preferably added in at least 0.25% by weight (calculated as the wet weight of the piggery effluent) in order to obtain satisfactory sequestration of phosphorus in the effluent. More suitably, the hydrotalcite is added in the range of 0.25 to 20% by weight of the wet weight of the piggery effluent.

### EXAMPLE 3

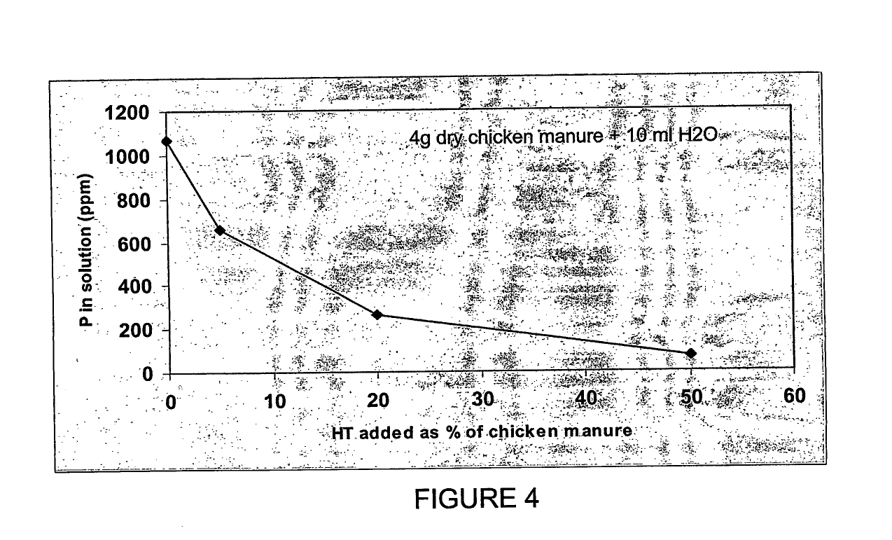

In example 3, chicken manure was recovered from a chicken feedlot and mixed with water. Various levels of hydrotalcite were then added and the treated chicken effluent tested for leachable phosphorus levels. The results are shown in FIG. 4. As can be seen from FIG. 4, it is preferred that the amount of hydrotalcite added to the chicken manure is at least 50%, calculated as a weight percentage of the dry weight of chicken manure. Preferably, the amount of hydrotalcite added to chicken manure is from 50-100 weight percent, calculated on the dry weight of the chicken manure.

Those skilled in the art will appreciate that the present invention may be susceptible to variations and modifications other than those specifically described. It is to be understood that the present invention encompasses all such variations and modifications that fall within its spirit and scope.

1. A method for treating waste material containing manure from animal feedlots, the method including the steps of mixing the material with a layered double hydroxide material, optionally a clay material and optionally water to form a mixture, said layered double hydroxide material being added in an amount sufficient to sequester anions present in the waste sludge or slurry, said layered double hydroxide material and optionally clay material and optionally water being added in an amount sufficient to form a workable mixture for granulating, and subjecting the mixture to a granulating process and a drying process to form dried granules.

2. A method as claimed in claim 1 wherein the amount of layered double hydroxide material added to the waste material is determined by adding trial amounts of layered double hydroxide material to a sample of the waste material, analysing a liquid component from the waste material for anion content, selecting a liquid component having a desired or pre-determined anion content and selecting the amount of layered double hydroxide material added to the waste sample from which the selected liquid component was obtained as the determined amount of layered double hydroxide material.

3. A method as claimed in claim 2 wherein the amount of layered double hydroxide material added to the waste material is in excess of the determined amount.

4. A method as claimed in claim 1 wherein the amount of layered double hydroxide material to be added to the waste material is determined by determining the amount of soluble anions in the waste material and adding at least sufficient LDH material to sequester the determined amount of soluble anions.

5. A method as claimed in claim 4 wherein the waste material is a waste sludge or slurry and the amount of layered double hydroxide material added to the waste sludge or slurry is determined by determining the amount of dissolved anions and leachable anions in the waste sludge or slurry and adding at least sufficient layered double hydroxide material to sequester the determined amount of dissolved and leachable anions.

6. A method as claimed in claim 4 wherein the amount of layered double hydroxide material added to the waste sludge or slurry is in excess of the amount required to sequester the determined amount of dissolved and leachable anions.

7. A method as claimed in claim 5 wherein the amount of layered double hydroxide material that is added to sequester the determined amount of dissolved and leachable anions is determined by determining the anion exchange capacity of the layered double hydroxide material, and calculating the amount of layered double hydroxide material required to sequester the determined amount of dissolved and leachable anions.

8. A method as claimed in claim 5 wherein the amount of dissolved and leachable anions present in the waste sludge or slurry is determined by separating the sludge or slurry into a liquid fraction and a solid fraction, analysing the liquid fraction to determine the amount of dissolved anions, and subjecting the solid fraction to a leaching test to determine the amount of leachable anions.

9. A method as claimed in claim 1 wherein the layered double hydroxide material is preferably of the general formula (1):
M₁₋ₓ²⁺Mₓ³⁺(OH)₂A_{x/n}ⁿ⁻yH₂O (1)
where M²⁺ and M³⁺ are di- and tri-valent metal ions respectively and Aⁿ⁻ is the interlayer anion of valance n, the x value represents the proportion of trivalent metal to the total amount of metal ion present and y denotes variable amounts of interlayer water.

10. A method as claimed in claim 9 wherein the metal ions are selected from Mg²⁺, Al³⁺, Mg²⁺, Fe³⁺ and other cations including Ni, Zn, Mn, Ca, Cr, and La.

11. A method as claimed in claim 10 wherein the metal ions are Mg²⁺ and Al³⁺ and the layered double hydroxide material is a hydrotalcite.

12. A method as claimed in claim 11 wherein the hydrotalcite Cl⁻ ions or nitrate ions as its interlayer anions.

13. A method as claimed in claim 1 wherein the clay material is added and the clay material is selected from natural clays and synthetic clays.

14. A method as claimed in claim 13 wherein the natural clays are selected from bentonite, montmorillonite, kaolinite, halloysite, illite, chlorite, attapulgite and allophane or mixtures of two or more thereof.

15. A method as claimed in claim 14 wherein the natural clay is bentonite.

16. A method as claimed in claim 13 wherein the synthetic clays are selected from dawsonite or XAM.

17. A method as claimed in claim 1 wherein the granulating processes is selected from granulating using rotating inclined tables, rotating drums, fluidised beds, high speed choppers or extrusion.

18. A method as claimed in claim 1 wherein the drying step forms part of the granulating process or takes place as a separate step to the formation of the granules.

19. A method as claimed in claim 18 wherein the drying step is carried out by passing the granules through a drier operated at elevated temperature.

20. A method as claimed in claim 19 wherein the drier is operated at a temperature of from 20° C. to 100° C.

21. A method as claimed in claim 1 wherein the waste material is a waste sludge or slurry having a high water content, and the method further includes the steps of removing part of the water from the waste slurry or sludge prior to contacting with the layered double hydroxide material and the clay material and treating the removed part of the water to remove dissolved anions therefrom.

22. A method as claimed in claim 21 wherein the removed part of the water may be contacted with a layered double hydroxide material to remove dissolved anions.

23. A method as claimed in claim 22 wherein the removed part of the water is contacted with hydrotalcite containing nitrate as an interlayer anion and nitrate anions are not removed from the water and the water is subjected to a denitrification process.

24. A method as claimed in claim 22 wherein the layered double hydroxide material that is used to treat the removed part of the water does not become saturated with the anions removed from the water and the layered double hydroxide material that is contacted with the water is added to the waste sludge or slurry, either as all of the layered double hydroxide material added to the waste sludge or slurry or as a complement to other layered double hydroxide material added to the waste sludge or slurry.

25. A method as claimed in claim 1 wherein the waste material is a waste sludge or slurry having a high water content, and the method further includes the steps of removing part of the water from the waste slurry or sludge prior to contacting with the layered double hydroxide material and the clay material and reusing the water.

26. A method as claimed in claim 1 wherein the waste material is a relatively dry material, such as chicken manure from a battery farm, and water is added to the waste material in order to obtain a workable mixture.

27. A method as claimed in claim 26 wherein the water is added to the waste material prior to mixing with the layered double hydroxide material or added together with or after addition of one or both of the layered double hydroxide material and the clay material to the waste material.

28. A method as claimed in claim 1 wherein the granules are subjected to a disinfection treatment to kill deleterious organisms therein.

29. A method as claimed in claim 28 wherein the disinfection treatment is a heat treatment or an irradiation treatment.

30. A method as claimed in claim 29 wherein the disinfection treatment is a heat treatment that is or forms part of the drying step.
